(19) United States
(12) Patent Application Publication
(10) Pub. No.: US 2025/0044739 A1
(43) Pub. Date: Feb. 6, 2025

(54) HOLOGRAPHIC PRINTER USING MECHANICAL SHUTTER HAVING ADJUSTABLE EXPOSURE TIME AND NO VIBRATION

(71) Applicant: Korea Electronics Technology Institute, Seongnam-si (KR)

(72) Inventors: Sung Hee HONG, Seoul (KR); Young Min KIM, Seoul (KR); Ji Soo HONG, Seoul (KR)

(73) Assignee: Korea Electronics Technology Institute, Seongnam-si (KR)

(21) Appl. No.: 18/713,918

(22) PCT Filed: Dec. 7, 2021
(86) PCT No.: PCT/KR2021/018427

§ 371 Date: May 28, 2024

(30) Foreign Application Priority Data
Dec. 7, 2021 (KR) 10-2021-0173360

(51) Int. Cl. G03H 1/04

(52) U.S. Cl. CPC G03H 1/0476; G03H 2001/048; G03H 2227/03

(57) ABSTRACT

Provided is a holographic printer using a mechanical shutter having adjustable exposure time and no vibration. The holographic printer according to an embodiment of the present invention comprises: a light source; a modulator for generating a holographic fringe pattern in hogel units; a stage on which a hologram recording medium is placed; a driving part for moving the position of the stage in hogel units; and a shutter for periodically exposing an object light due to the holographic fringe pattern generated by the modulator to the hologram recording medium. The shutter comprises: a rotation plate having formed therein an arc-shaped opening which exposes the object light due to the holographic fringe pattern; and a motor for rotating the rotation plate. Therefore, the exposure period and exposure time of the shutter can be variously adjusted by adjusting the rotational state of the rotation plates having the arc-shaped opening formed therein.

### TECHNICAL FIELD

The disclosure relates to a holographic printer, and more particularly, to a holographic printer which records a hologram on a hologram recording medium on a hogel basis.

### BACKGROUND ART

FIG. 1 is a view illustrating a hologram recording process of a holographic printer. A hologram may be recorded in the unit of a hogel, which is a part obtained by dividing a hologram in a grid pattern. A hogel of a hologram may be understood as a concept corresponding to a pixel of an image.

The process illustrated in FIG. 1 is a process of recording one hogel. As shown in the drawing, a stage on which a hologram recording medium on which a hologram is to be recorded is placed may be moved and stopped, and then, a hologram image of a corresponding hogel may be uploaded and a hologram of the corresponding hogel may be recorded on the hologram recording medium by operating (opening)/stopping (closing) a shutter.

FIG. 2 is a view illustrating a shutter of a holographic printer. The shutter used in the holographic printer may be a mechanical shutter, and switches between an open state and a closed state as shown in the drawing. However, a vibration may be accompanied when the shutter is opened (shutter-on) and closed (shutter-off) as shown in FIG. 3.

However, a holographic printer may be vulnerable to a vibration and thus a vibration of a shutter may degrade hologram recording quality.

### DISCLOSURE

### Technical Problem

The disclosure has been developed in order to address the above-discussed deficiencies of the prior art, and an object of the disclosure is to provide a holographic printer using a vibration-free mechanical shutter as a solution to prevent hologram recording quality from being degraded by a vibration generated in the process of opening/closing the shutter.

In addition, an object of the disclosure is to provide a method for variously adjusting an exposure period and an exposure time of a vibration-free mechanical shutter.

### Technical Solution

According to an embodiment of the disclosure to achieve the above-described object, a holographic printer may include: a light source configured to emit light; a modulator configured to generate a holographic fringe pattern on a hogel basis by modulating light emitted from the light source; a stage on which a hologram recording medium is placed, the holographic fringe pattern generated by the modulator being recorded on the hologram recording medium on a hogel basis; a driver configured to move a position of the stage on a hogel basis; and a shutter configured to periodically expose object light generated by the holographic fringe pattern generated by the modulator to the hologram recording medium, and the shutter may include: a first rotation plate having an arc-shaped opening formed thereon to expose object light generated by the hologram fringe pattern; and a first motor configured to rotate the first rotation plate.

In addition, a length of the arc on the first rotation plate may be determined by an exposure time of the shutter.

According to an embodiment of the disclosure, the holographic printer may further include a controller configured to control a speed of the first motor to control an exposure period of the shutter.

The speed of the first motor may be determined by a moving speed of the stage.

The shutter may further include: a second rotation plate which has an arc-shaped opening formed thereon to expose object light generated by the holographic fringe pattern; and a second motor configured to rotate the second rotation plate in the opposite direction of the first rotation plate.

A section where the shutter opens may be a section where the opening formed on the first rotation plate and the opening formed on the second rotation plate meet each other.

An exposure period and an exposure time of the shutter may be determined by a rotation state of the first rotation plate and a rotation state of the second rotation plate.

According to another embodiment of the disclosure, a hologram recording method may include: a step of emitting light; a step of generating a holographic fringe pattern on a hogel basis by modulating emitted light; a step of moving a position of a stage on which a hologram recording medium, on which the generated holographic fringe pattern is to be recorded on a hogel basis, is placed on a hogel basis; and a step of periodically exposing object light generated by the generated holographic fringe pattern to the hologram recording medium by using a shutter, and the shutter may include: a first rotation plate having an arc-shaped opening formed thereon to expose object light generated by the hologram fringe pattern; and a first motor configured to rotate the first rotation plate.

### Advantageous Effects

As described above, according to embodiments of the disclosure, a vibration-free mechanical shutter may be applied to a holographic printer, so that hologram recording quality may be prevented from being degraded by a vibration generated in the process of opening/closing a shutter.

In addition, according to embodiments of the disclosure, an exposure period and an exposure time of a shutter may be variously adjusted by adjusting rotation states of rotation plates having an arc-shaped opening formed thereon.

### DESCRIPTION OF DRAWINGS

FIG. 1 is a view illustrating a hologram recording process of a holographic printer;

FIG. 2 is a view illustrating a shutter of a holographic printer;

FIG. 3 is a view illustrating a vibration accompanied by opening/closing of a shutter;

FIG. 4 is a view illustrating a structure of a holographic printer according to an embodiment of the disclosure;

FIG. 5 is a view illustrating a detailed structure of the shutter;

FIG. 6 is a view illustrating the rotation plate shown in FIG. 5 as viewed from the front;

FIGS. 7A to 7D are views provided to explain a shutter state caused by the rotation plate;

FIGS. 8 and 9 are views provided to explain an exposure period adjustment method of the shutter; and

FIG. 10 is a view illustrating a shutter of a structure different from that of FIG. 5.

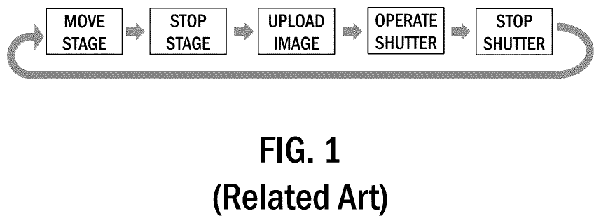

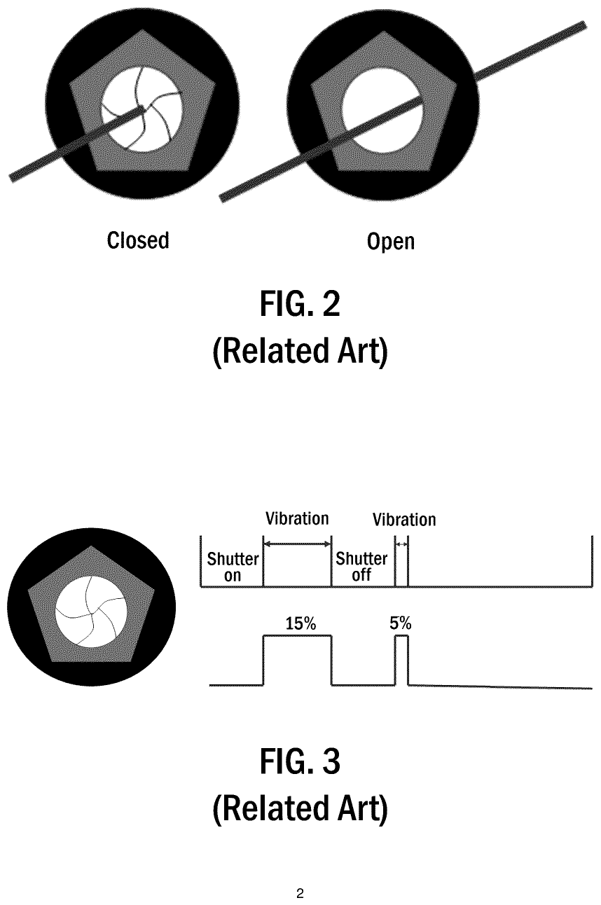

### Best Mode

Hereinafter, the disclosure will be described in more detail with reference to the drawings.

Embodiments of the disclosure provide a holographic printer using a mechanical shutter having an adjustable exposure time and no vibration.

Specifically, a holographic printer according to an embodiment of the disclosure uses a shutter that is operated by rotating a rotation plate having an opening formed thereon and exposing object light generated by a holographic fringe pattern to a hologram recording medium, rather than using a shutter operated by opening and closing.

Furthermore, the holographic printer according to an embodiment of the disclosure may adjust an exposure period and an exposure time by rotating one pair of rotation plates in opposite directions to each other.

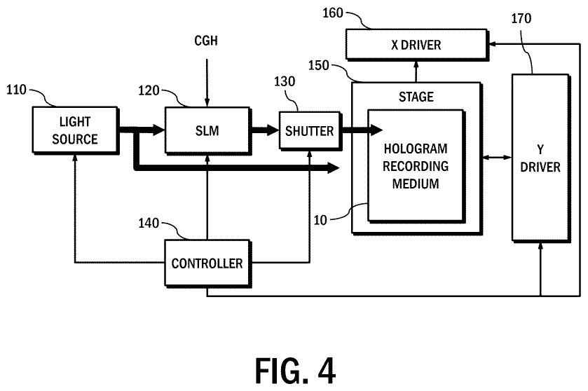

FIG. 4 is a view illustrating a structure of a holographic printer according to an embodiment of the disclosure. The holographic printer according to an embodiment of the disclosure may include a light source 110, a spatial light modulator (SLM) 120, a shutter 130, a controller 140, a stage 150, an X-driver 160 and a Y-driver 170 as shown in the drawing.

The light source 110 emits light which is used for generating object light and reference light required to generate a hologram. The light source 110 may be implemented by a laser light source.

Light emitted from the light source 110 may be split by a beam splitter (not shown), such that a part of the light is applied to the SLM 120 and the other part of the light enters a hologram recording medium 10 through an optical system as reference light.

The SLM 120 may generate a holographic fringe pattern by modulating light entering from the light source 110, based on a computer generated hologram (CGH) generated by a hologram generation system (not shown) which is a computing system.

The holographic fringe pattern is generated at the SLM 120 on a hogel basis. Accordingly, a CGH image may be generated at the hologram generation system on a hogel basis and may be applied to the SLM 120 on a hogel basis.

The shutter 130 may periodically switch between an open state and a closed state to periodically expose object light generated by the holographic fringe pattern generated at the SLM 120 to the hologram recording medium 10.

While the shutter 130 is open, a hologram which is an interference fringe of object light generated by the holographic fringe pattern and reference light generated by a part of light split from the light source 110 may be recorded on a corresponding hogel area of the hologram recording medium 10.

The hologram recording medium 10 may be placed on the stage 150, and the X-driver 160 and the Y-driver 170 may move the stage 150 in X-axis and Y-axis directions to allow a hologram to be recorded on the hologram recording medium 10 on a hogel basis.

The controller 140 may control turning on/off of the light source 110, a modulating operation of the SLM 120, a period and a speed of the shutter 130, and movement of the stage 150 by the X-driver 160 and the Y-driver 170.

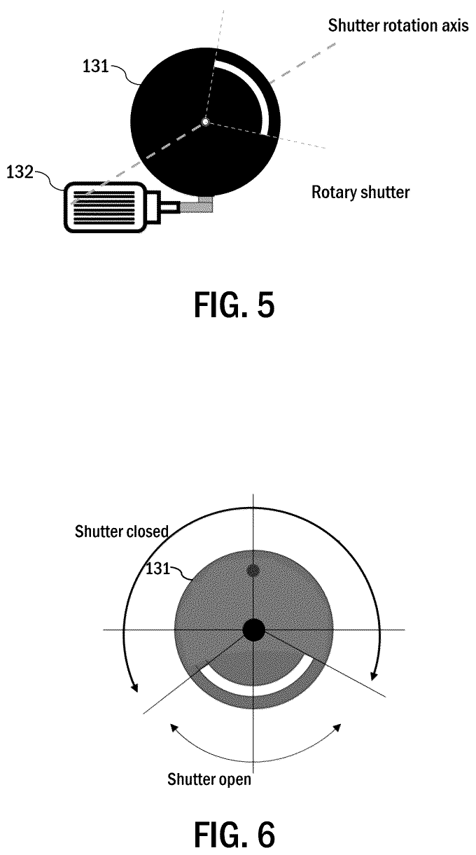

FIG. 5 is a view illustrating a detailed structure of the shutter 130. The shutter 130 may include a rotation plate 131 and a servo motor 132 as shown in the drawing.

The rotation plate 131 is a circular plate that has an arc-shaped opening formed thereon to expose object light generated by the holographic fringe pattern generated by the SLM 120 to the hologram recording medium 10.

FIG. 6 is a view illustrating the rotation plate 131 as viewed from the front. The section of the rotation plate 131 where the opening is formed is the section where the shutter opens, and the section where the opening is not formed is the section where the shutter is closed.

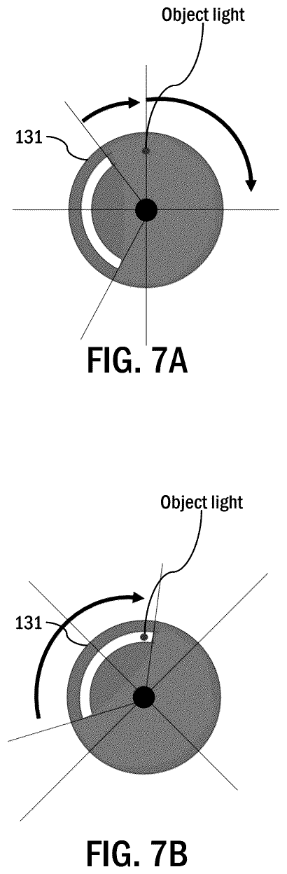

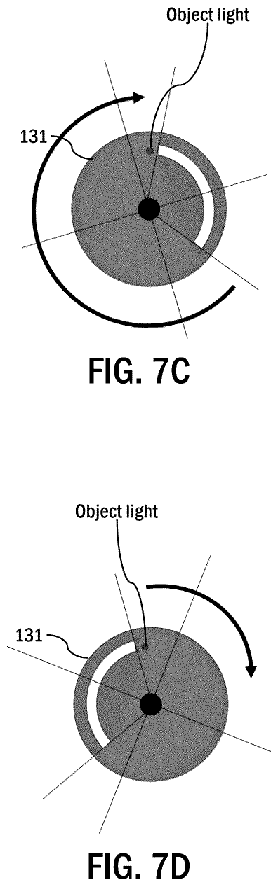

That is, when the rotation plate 131 rotates as shown in FIGS. 7A to 7D, the shutter is closed in the state (FIG. 7A), is opened and exposes object light in the state (FIG. 7B), and is closed again and block object light in the state (FIG. 7C and FIG. 7D).

As can be seen through the drawing, an exposure time of the shutter 130 may be determined according to a length of the opening (in other words, a center angle of the arc) on the rotation plate 131.

The servo motor 132 is configured to rotate the rotation plate 131 at a uniform velocity. Since the servo motor 132 does not almost generate a vibration when rotating, a vibration does not occur when the shutter 130 switches between an open state and a closed state as shown in FIG. 7.

The controller 140 may control an exposure period of the shutter 130 by controlling a rotation speed of the servo motor 132. Specifically, when the rotation speed of the servo motor 132 increases, the exposure period of the shutter 130 may become shorter, and, when the rotation speed of the servo motor 132 decreases, the exposure period of the shutter 130 may become longer.

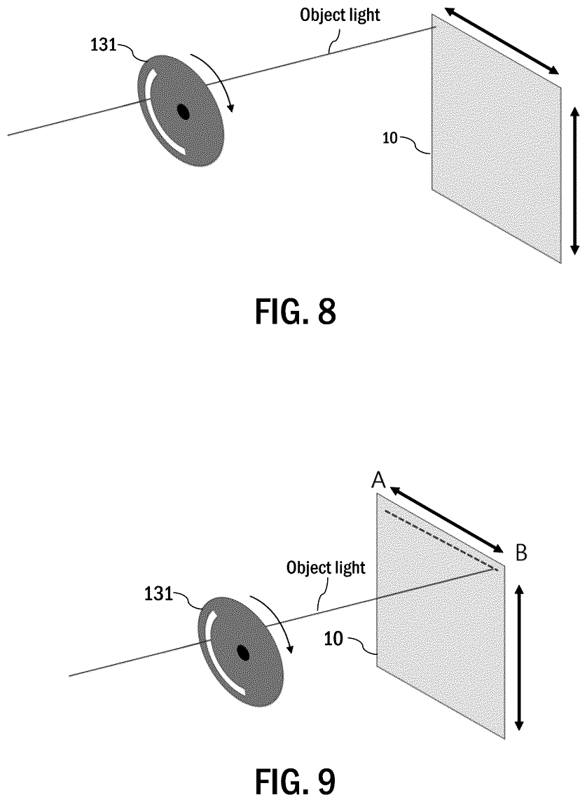

The exposure period of the shutter 130 should be synchronized with a moving speed of the stage 150, that is, a moving speed of the hologram recording medium 10 placed on the stage 150. That is, while the hologram recording medium 10 is moving from the state of FIG. 8 to the state of FIG. 9, the shutter 130 should open to allow object light to enter a center of each hogel of the hologram recording medium.

If there are 1000 hogels in one line of the hologram recording medium 10 and time taken to move the stage 150 from the state of FIG. 8 to the state of FIG. 9 is 100 seconds, the exposure period of the shutter 130 should be 0.1 second (=100/1000). That is, the shutter 130 should open every 0.1 second, and to do this, the controller 140 should control the rotation speed of the servo motor 132.

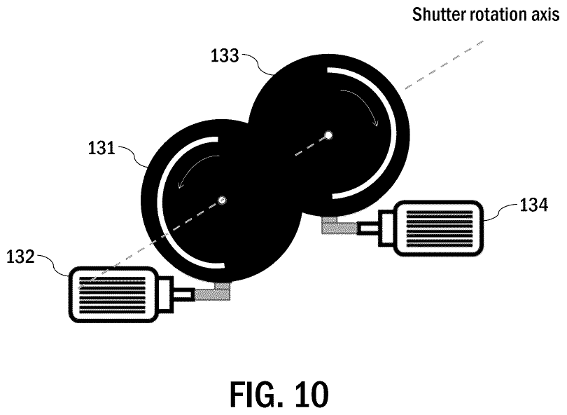

FIG. 10 illustrates a shutter 130 of a structure different from that of FIG. 5. The shutter 130 of FIG. 10 is different from the shutter 130 of FIG. 5, which has one rotation plate and one servo motor, in that a rotation plate 133 and a servo motor 134 are further included such that one pair of rotation plates and one pair of servo motors are implemented.

As shown in the drawing, the rotation plate 131 and the rotation plate 133 rotate in opposite directions, and accordingly, the section where the shutter 130 opens is the section where the opening formed on the rotation plate 131 and the opening formed on the rotation plate 133 meet each other.

Accordingly, by adjusting a rotation state (a rotation starting time and a rotation speed) of the rotation plate 131 and a rotation state (a rotation starting time and a rotation speed) of the rotation plate 133, not only the exposure period of the shutter 130 but also the exposure time may be adjusted.

That is, the exposure period and the time of the shutter 130 may be determined by the rotation state of the rotation plate 131 and the rotation state of the rotation plate 133.

Up to now, a holographic printer using a mechanical shutter having an adjustable exposure time and no vibration has been described with reference to preferred embodiments.

An embodiment of the disclosure proposes a structure which rotates a rotation plate having an opening formed thereon through a servo motor and periodically exposes object light generated by a holographic fringe pattern to a hologram recording medium in order to remove a vibration which may be produced by a related-art mechanical shutter.

Furthermore, an embodiment of the disclosure proposes a structure and a method for adjusting an exposure period and an exposure time concurrently by rotating one pair of rotation plates in opposite directions to each other.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A holographic printer comprising:
a light source configured to emit light;
a modulator configured to generate a holographic fringe pattern on a hogel basis by modulating light emitted from the light source;
a stage on which a hologram recording medium is placed, the holographic fringe pattern generated by the modulator being recorded on the hologram recording medium on a hogel basis;
a driver configured to move a position of the stage on a hogel basis; and
a shutter configured to periodically expose object light generated by the holographic fringe pattern generated by the modulator to the hologram recording medium,
wherein the shutter comprises: a first rotation plate having an arc-shaped opening formed thereon to expose object light generated by the hologram fringe pattern; and a first motor configured to rotate the first rotation plate.

2. The holographic printer of claim 1, wherein a length of the arc on the first rotation plate is determined by an exposure time of the shutter.

3. The holographic printer of claim 1, further comprising a controller configured to control a speed of the first motor to control an exposure period of the shutter.

4. The holographic printer of claim 3, wherein the speed of the first motor is determined by a moving speed of the stage.

5. The holographic printer of claim 1, wherein the shutter further comprises:
a second rotation plate which has an arc-shaped opening formed thereon to expose object light generated by the holographic fringe pattern; and
a second motor configured to rotate the second rotation plate in the opposite direction of the first rotation plate.

6. The holographic printer of claim 5, wherein a section where the shutter opens is a section where the opening formed on the first rotation plate and the opening formed on the second rotation plate meet each other.

7. The holographic printer of claim 6, wherein an exposure period and an exposure time of the shutter are determined by a rotation state of the first rotation plate and a rotation state of the second rotation plate.

8. A hologram recording method comprising:
a step of emitting light;
a step of generating a holographic fringe pattern on a hogel basis by modulating emitted light;
a step of moving a position of a stage on which a hologram recording medium, on which the generated holographic fringe pattern is to be recorded on a hogel basis, is placed on a hogel basis; and
a step of periodically exposing object light generated by the generated holographic fringe pattern to the hologram recording medium by using a shutter,
wherein the shutter comprises: a first rotation plate having an arc-shaped opening formed thereon to expose object light generated by the hologram fringe pattern; and a first motor configured to rotate the first rotation plate.
